(19) United States
(12) Patent Application Publication
(10) Pub. No.: US 2006/0080043 A1
(43) Pub. Date: Apr. 13, 2006

(54) Comparative genomic hybridization significance analysis using data smoothing with shaped response functions

(76) Inventors: Nicholas M. Sampas, San Jose, CA (US); Bo Curry, Redwood City, CA (US)

Correspondence Address: AGILENT TECHNOLOGIES, INC.;INTELLECTUAL PROPERTY ADMINISTRATION, LEGAL DEPT., P.O. BOX 7599, M/S DL429, LOVELAND, CO, 80537-0599, US

(21) Appl. No.: 10/963,883

(22) Filed: Oct. 12, 2004

(51) Int. Cl. G06F 19/00

(52) U.S. Cl. 702/20

(57) ABSTRACT

Methods and systems for analyzing comparative genomic hybridization data. The methods comprise measuring comparative genomic hybridization data, and applying a shaped response function to the comparative genomic hybridization data, wherein the shaped response function has a central maximum. The comparative genomic hybridization data may be obtained from a comparative genomic hybridization array. The shaped response function in many embodiments is symmetrical in shape tapers to zero on each side of said central maximum.

### FIELD OF THE INVENTION

The invention relates to methods for smoothing comparative genomic hybridization data, and in particular data from comparative genome hybridization arrays.

### BACKGROUND OF THE INVENTION

Many events during the cell cycle can cause genomic instability through the deletion, duplication or translocation of DNA regions and result in alterations in DNA copy sequence number. Cancer progression often involves such changes in DNA copy number via over-expression of oncogenes and inactivation of tumor suppressor genes. Comparative genomic hybridization (CGH) is an important experimental technique that allows genome-wide analysis of DNA sequence copy number. The use of arrays for comparative genomic hybridization (aCGH) allows simultaneous evaluation of copy numbers at multiple positions across an entire genome, and provides a tool for clinical evaluation of cancer progression.

In a typical array CGH experiment, DNA from test cells is compared directly to DNA from normal cells. A glass slide or other array substrate is spotted with small DNA fragments from mapped genomic targets (i.e., DNA fragments of known identity and genomic position). A DNA test sample of interest and a DNA reference sample are each differentially labeled, and the combined test and reference samples are applied to the microarray. Intensity measurements for the genomic target sequences are then made to determine variations in copy number. Since the reference sample is generally diploid across the genome, target sequences with test intensities greater than the reference intensities indicate a gain in copy number, while lower intensities in the test sample indicated a loss in copy number.

Hybridization of complex genomic samples to microarrays often results in a signal-to-noise ratio that is poor for individual probes. Such noise may include compression of ratios due to aneuploidy, the existence of polymorphic sites, experimental noise, or other sources. Noise level can make it difficult to exactly determine change points (locations where a change in copy number occurs) and the actual values of copy numbers. Thus, in analyzing array CGH data, it has become common to employ some form of data smoothing to reduce noise.

Since array CGH data is usually represented as a function of the positions of the probes along a chromosome, moving average data smoothing techniques are commonly employed. In the moving average data smoothing method, the data at each point is replaced by the average value of the point of interest and a selected number of neighboring points. Moving average data smoothing has proved to be non-optimal, however, as it tends to minimize localized copy number changes and obscure copy number changes associated with a single point on a chromosome.

There is accordingly a need for a data smoothing method that improves resolution of array CGH data, and does not minimize or obscure localized or single point copy number changes. The present invention satisfies these needs as well as others, and overcomes the deficiencies found in the background art.

Relevant Literature

Relevant literature includes U.S. Pat. No. 6,465,182; U.S. Pat. No. 6,335,167; U.S. Pat. No. 6,251,601; U.S. Pat. No. 6,210,878; U.S. Pat. No. 6,197,501; U.S. Pat. No. 6,159,685; U.S. Pat. No. 5,965,362; U.S. Pat. No. 5,830,645; U.S. Pat. No. 5,665,549; U.S. Pat. No. 5,447,841; U.S. Pat. No. 5,348,855; US2002/0006622; WO 99/23256; Pollack et al., Proc. Natl. Acad. Sci. (2002) 99: 12963-12968; Wilhelm et al., Cancer Res. (2002) 62: 957-960; Pinkel et al., Nat. Genet. (1998) 20: 207-211; Cai et al., Nat. Biotech. (2002) 20: 393-396; Snijders et al., Nat. Genet. (2001) 29:263-264; Hodgson et al., Nat. Genet. (2001) 29:459-464; Trask, Nat. Rev. Genet. (2002) 3: 769-778; Rabinovitch et al., Cancer Res. (1999) 59:5148-5153; Lee et al., Human Genet. (1997) 100:291:304; and Jong et al., Bioinformatics Advanced Access, Oxford University Press, Jul. 16, 2004.

### SUMMARY OF THE INVENTION

The invention provides methods and systems for data smoothing of array CGH data with improved resolution of localized and single point copy number variation. In general terms, the subject methods comprise measuring comparative genomic hybridization data, and applying a shaped response function to the comparative genomic hybridization data, wherein the shaped response function has a central maximum.

By way of example, and not of limitation, the comparative genomic hybridization data may be obtained from a comparative genomic hybridization array. The shaped response function in many embodiments tapers to zero on each side of said central maximum. In many embodiments, the shaped response function is symmetrical in shape about the central maximum.

In certain embodiments the shaped response function is a Gaussian-shaped response function of the formula:

$$w ( x ) = \frac{{ⅇ}^{- {x}^{2} / ( 2 {σ}^{2} )}}{σ \sqrt{2 π}}$$

wherein σ is the 1/e width of the Gaussian, and x is the data point position. The 1/e width of the Gaussian-shaped response function may be selected such that the value of σ is equal about 1.349 times the nominal window width.

In certain embodiments the shaped response function is a Lorentzian-shaped response function of the formula:

$$w ( x ) = \frac{W}{π ( {W}^{2} + {x}^{2} )}$$

wherein W is the full width half maximum of the Lorentzian-shaped response function, and x is the data point position.

The value of W in the Lorentzian-shaped response function may be chosen to equal four times the nominal window width.

In certain embodiments the shaped response function is a triangle-shaped response function.

In other embodiments, the shaped response function may be a biexponential response function of the formula:
w(x)=e^{-|x|/δ}/2δ
wherein x is data point position and δ is the decay rate. The value of δ of the biexponential response function may be chosen to be 2 ln 2 times the nominal window width.

In certain embodiments, the invention may further comprise calculating significance levels for smoothed data obtained from applying the shaped response function to the comparative genomic hybridization array data.

The invention also provides a comparative genomic hybridization array data analysis system, and corresponding programming in a computer readable medium, comprising means for applying a shaped response function to comparative genomic hybridization array data, the shaped response function having a central maximum and symmetrically tapering to zero on each side of said central maximum, and means for determining significance levels for smoothed data obtained from applying the shaped response function to the comparative genomic hybridization array data. In certain embodiments the system may further comprise means for generating a graphical representation of said smoothed data.

These and other advantages and features of the invention will become apparent to those persons skilled in the art upon reading the details more fully described below.

### BRIEF DESCRIPTION OF THE DRAWINGS

FIG. 1 is a graphical representation of a square-shaped response function as used in prior art moving average data smoothing.

FIG. 2 is a graphical representation of a Gaussian-shaped response function for data smoothing in accordance with the invention.

FIG. 3 is a graphical representation of a Lorentzian-shaped response function for data smoothing in accordance with the invention.

FIG. 4 is a graphical representation of a triangle-shaped response function for data smoothing in accordance with the invention.

FIG. 5 is a flow chart illustrating a data smoothing method for CGH arrays in accordance with the invention.

FIG. 6 is a block diagram illustrating an example of a computer system which may be used in implementing the present invention.

FIG. 7 is a graphical representation of raw microarray data (log₂[Test/Reference] vs. position) for Human Chromosome 16 (HCT116) with probe positions from 70 MB to 90 MB.

FIG. 8 is a graphical representation of the microarray data of FIG. 5 after data smoothing with a square window (“moving average”) shaped response function having a window width of 1 MB. FIG. 9 is a graphical representation of the microarray data of FIG. 5 after data smoothing with a Lorentzian-shaped response function in accordance with the invention, having a window width of 500 kB. FIG. 10 is a graphical representation of the microarray data of FIG. 5 after data smoothing with a Gaussian-shaped response function in accordance with the invention, having a window width of 500 kB.

FIG. 11 is a graphical representation of the microarray data of FIG. 5 after data smoothing with a triangle-shaped response function in accordance with the invention, having a window width of 500 kB.

FIG. 12 is a graphical representation of the microarray data of FIG. 5 after data smoothing with a square window (“moving average”) shaped response function having a window width of 2 MB. FIG. 13 is a graphical representation of the microarray data of FIG. 5 after data smoothing with a Lorentzian-shaped response function in accordance with the invention, having a window width of 1 MB. FIG. 14 is a graphical representation of the microarray data of FIG. 5 after data smoothing with a Gaussian-shaped response function in accordance with the invention, having a window width of 1 MB.

FIG. 15 is a graphical representation of the microarray data of FIG. 5 after data smoothing with a triangle-shaped response function in accordance with the invention, having a window width of 1 MB.

### DETAILED DESCRIPTION OF THE INVENTION

Before the present methods for array CGH data smoothing are described, it is to be understood that this invention is not limited to particular genes or chromosomes described, as such may, of course, vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limits of that range is also specifically disclosed. Each smaller range between any stated value or intervening value in a stated range and any other stated or intervening value in that stated range is encompassed within the invention. The upper and lower limits of these smaller ranges may independently be included or excluded in the range, and each range where either, neither or both limits are included in the smaller ranges is also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, the preferred methods and materials are now described. All publications mentioned herein are incorporated herein by reference to disclose and describe the methods and/or materials in connection with which the publications are cited.

It should be noted that as used herein and in the appended claims, the singular forms “a”, “and”, and “the” include plural referents unless the context clearly dictates otherwise. Thus, for example, reference to “a polynucleotide” includes a plurality of such polynucleotides and reference to “the target fragment” includes reference to one or more target fragment and equivalents thereof known to those skilled in the art, and so forth.

The publications discussed herein are provided solely for their disclosure prior to the filing date of the present application. Nothing herein is to be construed as an admission that the present invention is not entitled to antedate such publication by virtue of prior invention. Further, the dates of publication provided may be different from the actual publication dates which may need to be independently confirmed.

Definitions

The term “nucleic acid” and “polynucleotide” are used interchangeably herein to describe a polymer of any length, e.g., greater than about 10 bases, greater than about 100 bases, greater than about 500 bases, greater than 1000 bases, usually up to about 10,000 or more bases composed of nucleotides, e.g., deoxyribonucleotides or ribonucleotides, or compounds produced synthetically (e.g., PNA as described in U.S. Pat. No. 5,948,902 and the references cited therein) which can hybridize with naturally occurring nucleic acids in a sequence specific manner analogous to that of two naturally occurring nucleic acids, e.g., can participate in Watson-Crick base pairing interactions.

The terms “ribonucleic acid” and “RNA” as used herein mean a polymer composed of ribonucleotides.

The terms “deoxyribonucleic acid” and “DNA” as used herein mean a polymer composed of deoxyribonucleotides.

The term “oligonucleotide” as used herein denotes single stranded nucleotide multimers of from about 10 to 100 nucleotides and up to 200 nucleotides in length. Oligonucleotides are usually synthetic and, in many embodiments, are under 60 nucleotides in length.

The term “oligomer” is used herein to indicate a chemical entity that contains a plurality of monomers. As used herein, the terms “oligomer” and “polymer” are used interchangeably, as it is generally, although not necessarily, smaller “polymers” that are prepared using the functionalized substrates of the invention, particularly in conjunction with combinatorial chemistry techniques. Examples of oligomers and polymers include polydeoxyribonucleotides (DNA), polyribonucleotides (RNA), other nucleic acids that are C-glycosides of a purine or pyrimidine base, polypeptides (proteins), polysaccharides (starches, or polysugars), and other chemical entities that contain repeating units of like chemical structure.

The term “sample” as used herein relates to a material or mixture of materials, typically, although not necessarily, in fluid form, containing one or more components of interest.

The terms “nucleoside” and “nucleotide” are intended to include those moieties that contain not only the known purine and pyrimidine bases, but also other heterocyclic bases that have been modified. Such modifications include methylated purines or pyrimidines, acylated purines or pyrimidines, alkylated riboses or other heterocycles. In addition, the terms “nucleoside” and “nucleotide” include those moieties that contain not only conventional ribose and deoxyribose sugars, but other sugars as well. Modified nucleosides or nucleotides also include modifications on the sugar moiety, e.g., wherein one or more of the hydroxyl groups are replaced with halogen atoms or aliphatic groups, or are functionalized as ethers, amines, or the like.

The phrase “surface-bound polynucleotide” refers to a polynucleotide “probe” that is immobilized on a surface of a solid substrate, where the substrate can have a variety of configurations, e.g., a sheet, bead, or other structure. In certain embodiments, the collections of oligonucleotide probe elements employed herein are present on a surface of the same planar support, e.g., in the form of an array.

A “labeled population of nucleic acids” refers to mixture of nucleic acids that are detectably labeled, e.g., fluorescently labeled, such that the presence of the nucleic acids can be detected by assessing the presence of the label. A labeled population of nucleic acids is “made from” a chromosome sample, and the chromosome sample is usually employed as template for making the population of nucleic acids.

The term “array” encompasses the term “microarray” and refers to an ordered array presented for binding to nucleic acids and the like.

An “array,” includes any two-dimensional or substantially two-dimensional (as well as a three-dimensional) arrangement of spatially addressable regions bearing nucleic acid probes, particularly oligonucleotides or synthetic mimetics thereof, and the like. Where the arrays are arrays of nucleic acids, the nucleic acid probes may be adsorbed, physisorbed, chemisorbed, or covalently attached to the arrays at any point or points along the nucleic acid chain.

Any given substrate may carry one, two, four or more arrays disposed on a front surface of the substrate. Depending upon the use, any or all of the arrays may be the same or different from one another and each may contain multiple spots or features. A typical array may contain one or more, including more than two, more than ten, more than one hundred, more than one thousand, more ten thousand features, or even more than one hundred thousand features, in an area of less than 20 cm² or even less than 10 cm², e.g., less than about 5 cm², including less than about 1 cm², less than about 1 mm², e.g., 100 μm², or even smaller. For example, features may have widths (that is, diameter, for a round spot) in the range from a 10 μm to 1.0 cm. In other embodiments each feature may have a width in the range of 1.0 μm to 1.0 mm, usually 5.0 μm to 500 μm, and more usually 10 μm to 200 μm. Non-round features may have area ranges equivalent to that of circular features with the foregoing width (diameter) ranges. At least some, or all, of the features are of different compositions (for example, when any repeats of each feature composition are excluded the remaining features may account for at least 5%, 10%, 20%, 50%, 95%, 99% or 100% of the total number of features). Inter-feature areas will typically (but not essentially) be present which do not carry any nucleic acids (or other biopolymer or chemical moiety of a type of which the features are composed). Such inter-feature areas typically will be present where the arrays are formed by processes involving drop deposition of reagents but may not be present when, for example, photolithographic array fabrication processes are used. It will be appreciated though, that the inter-feature areas, when present, could be of various sizes and configurations.

Each array may cover an area of less than 200 cm², or even less than 50 cm², 5 cm², 1 cm², 0.5 cm², or 0.1 cm². In certain embodiments, the substrate carrying the one or more arrays will be shaped generally as a rectangular solid (although other shapes are possible), having a length of more than 4 mm and less than 150 mm, usually more than 4 mm and less than 80 mm, more usually less than 20 mm; a width of more than 4 mm and less than 150 mm, usually less than 80 mm and more usually less than 20 mm; and a thickness of more than 0.01 mm and less than 5.0 mm, usually more than 0.1 mm and less than 2 mm and more usually more than 0.2 and less than 1.5 mm, such as more than about 0.8 mm and less than about 1.2 mm. With arrays that are read by detecting fluorescence, the substrate may be of a material that emits low fluorescence upon illumination with the excitation light. Additionally in this situation, the substrate may be relatively transparent to reduce the absorption of the incident illuminating laser light and subsequent heating if the focused laser beam travels too slowly over a region. For example, the substrate may transmit at least 20%, or 50% (or even at least 70%, 90%, or 95%), of the illuminating light incident on the front as may be measured across the entire integrated spectrum of such illuminating light or alternatively at 532 nm or 633 nm.

Arrays can be fabricated using drop deposition from pulse-jets of either nucleic acid precursor units (such as monomers) in the case of in situ fabrication, or the previously obtained nucleic acid. Such methods are described in detail in, for example, the previously cited references including U.S. Pat. No. 6,242,266, U.S. Pat. No. 6,232,072, U.S. Pat. No. 6,180,351, U.S. Pat. No. 6,171,797, U.S. Pat. No. 6,323,043, U.S. patent application Ser. No. 09/302,898 filed Apr. 30, 1999 by Caren et al., and the references cited therein. These references are incorporated herein by reference. Other drop deposition methods can be used for fabrication, as previously described herein. Also, instead of drop deposition methods, photolithographic array fabrication methods may be used. Inter-feature areas need not be present particularly when the arrays are made by photolithographic methods as described in those patents.

An array is “addressable” when it has multiple regions of different probes (e.g., different oligonucleotide sequences) such that a region (i.e., a “feature” or “spot” of the array) at a particular predetermined location (i.e., an “address”) on the array will detect a particular target sequence. Array features are typically, but need not be, separated by intervening spaces. It should be noted that the terms “target” and “probe” are sometimes used differently in certain publications.

A “scan region” refers to a contiguous (preferably, rectangular) area in which the array spots, probes or features of interest are found or detected. Where fluorescent labels are employed, the scan region is that portion of the total area illuminated from which the resulting fluorescence is detected and recorded. Where other detection protocols are employed, the scan region is that portion of the total area queried from which resulting signal is detected and recorded. For the purposes of this invention and with respect to fluorescent detection embodiments, the scan region includes the entire area of the slide scanned in each pass of the lens, between the first feature of interest, and the last feature of interest, even if there exist intervening areas that lack features of interest.

An “array layout” refers to one or more characteristics of the features, such as feature positioning on the substrate, one or more feature dimensions, and an indication of a moiety at a given location. “Hybridizing” and “binding”, with respect to nucleic acids, are used interchangeably.

The term “stringent assay conditions” as used herein refers to conditions that are compatible to produce binding pairs of nucleic acids, e.g., probes and targets, of sufficient complementarity to provide for the desired level of specificity in the assay while being incompatible to the formation of binding pairs between binding members of insufficient complementarity to provide for the desired specificity. The term stringent assay conditions refers to the combination of hybridization and wash conditions.

A “stringent hybridization” and “stringent hybridization wash conditions” in the context of nucleic acid hybridization (e.g., as in array, Southern or Northern hybridizations) are sequence dependent, and are different under different environmental parameters. Stringent hybridization conditions that can be used to identify nucleic acids within the scope of the invention can include, e.g., hybridization in a buffer comprising 50% formamide, 5×SSC, and 1% SDS at 42° C., or hybridization in a buffer comprising 5×SSC and 1% SDS at 65° C., both with a wash of 0.2×SSC and 0.1% SDS at 65° C. Exemplary stringent hybridization conditions can also include a hybridization in a buffer of 40% formamide, 1 M NaCl, and 1% SDS at 37° C., and a wash in 1×SSC at 45° C. Alternatively, hybridization to filter-bound DNA in 0.5 M NaHPO₄, 7% sodium dodecyl sulfate (SDS), 1 nmM EDTA at 65° C., and washing in 0.1×SSC/0.1% SDS at 68° C. can be employed. Yet additional stringent hybridization conditions include hybridization at 60° C. or higher and 3×SSC (450 mM sodium chloride/45 mM sodium citrate) or incubation at 42° C. in a solution containing 30% formamide, 1M NaCl, 0.5% sodium sarcosine, 50 mM MES, pH 6.5. Those of ordinary skill will readily recognize that alternative but comparable hybridization and wash conditions can be utilized to provide conditions of similar stringency.

In certain embodiments, the stringency of the wash conditions determine whether a nucleic acid is specifically hybridized to a probe. Wash conditions used to identify nucleic acids may include, e.g.: a salt concentration of about 0.02 molar at pH 7 and a temperature of at least about 50° C. or about 55° C. to about 60° C.; or, a salt concentration of about 0.15 M NaCl at 72° C. for about 15 minutes; or, a salt concentration of about 0.2×SSC at a temperature of at least about 50° C. or about 55° C. to about 60° C. for about 15 to about 20 minutes; or, the hybridization complex is washed twice with a solution with a salt concentration of about 2×SSC containing 0.1% SDS at room temperature for 15 minutes and then washed twice by 0.1×SSC containing 0.1% SDS at 68° C. for 15 minutes; or, equivalent conditions. Stringent conditions for washing can also be, e.g., 0.2×SSC/0.1% SDS at 42° C. In instances wherein the nucleic acid molecules are deoxyoligonucleotides (“oligos”), stringent conditions can include washing in 6×SSC/0.05% sodium pyrophosphate at 37° C. (for 14-base oligos), 48° C. (for 17-base oligos), 55° C. (for 20-base oligos), and 60° C. (for 23-base oligos). See Sambrook, Ausubel, or Tijssen (cited below) for detailed descriptions of equivalent hybridization and wash conditions and for reagents and buffers, e.g., SSC buffers and equivalent reagents and conditions.

Stringent hybridization conditions may also include a “prehybridization” of aqueous phase nucleic acids with complexity-reducing nucleic acids to suppress repetitive sequences. For example, certain stringent hybridization conditions include, prior to any hybridization to surface-bound polynucleotides, hybridization with Cot-1 DNA, or the like.

Stringent assay conditions are hybridization conditions that are at least as stringent as the above representative conditions, where a given set of conditions are considered to be at least as stringent if substantially no additional binding complexes that lack sufficient complementarity to provide for the desired specificity are produced in the given set of conditions as compared to the above specific conditions, where by “substantially no more” is meant less than about 5-fold more, typically less than about 3-fold more. Other stringent hybridization conditions are known in the art and may also be employed, as appropriate.

The term “mixture”, as used herein, refers to a combination of elements, that are interspersed and not in any particular order. A mixture is heterogeneous and not spatially separable into its different constituents. Examples of mixtures of elements include a number of different elements that are dissolved in the same aqueous solution, or a number of different elements attached to a solid support at random or in no particular order in which the different elements are not specially distinct. In other words, a mixture is not addressable. To be specific, an array of surface-bound polynucleotides, as is commonly known in the art and described below, is not a mixture of capture agents because the species of surface-bound polynucleotides are spatially distinct and the array is addressable.

“Isolated” or “purified” generally refers to isolation of a substance (compound, polynucleotide, protein, polypeptide, polypeptide, chromosome, etc.) such that the substance comprises the majority percent of the sample in which it resides. Typically in a sample a substantially purified component comprises 50%, preferably 80%-85%, more preferably 90-95% of the sample. Techniques for purifying polynucleotides, polypeptides and intact chromosomes of interest are well-known in the art and include, for example, ion-exchange chromatography, affinity chromatography, sorting, and sedimentation according to density.

The terms “assessing” and “evaluating” are used interchangeably to refer to any form of measurement, and include determining if an element is present or not. The terms “determining,” “measuring,” and “assessing,” and “assaying” are used interchangeably and include both quantitative and qualitative determinations. Assessing may be relative or absolute. “Assessing the presence of” includes determining the amount of something present, as well as determining whether it is present or absent.

If a surface-bound polynucleotide “corresponds to” a chromosome, the polynucleotide usually contains a sequence of nucleic acids that is unique to that chromosome. Accordingly, a surface-bound polynucleotide that corresponds to a particular chromosome usually specifically hybridizes to a labeled nucleic acid made from that chromosome, relative to labeled nucleic acids made from other chromosomes. Array features, because they usually contain surface-bound polynucleotides, can also correspond to a chromosome.

Methods

The data smoothing methods of the invention are described in terms of use with data derived from arrays or microarrays. It should be understood, however, that the invention may be used with any data that carries genomic copy number data, including data derived from arrays, polymerase chain reaction (PCR) experiments, cell sorting, or other techniques.

The invention is particularly useful in association with arrays capable of providing genomic copy number information. Arrays suitable for use in performing the subject methods may, for example, contain a plurality (i.e., at least about 100, at least about 500, at least about 1000, at least about 2000, at least about 5000, at least about 10,000, at least about 20,000, usually up to about 100,000 or more) of addressable features containing oligonucleotides that are linked to a usually planar solid support such as a glass or silicon substrate. Features on an array usually contain polynucleotides that hybridize to, i.e., bind to, genomic sequences from a cell. Such comparative genome hybridization arrays typically include a plurality of different oligonucleotides that are addressably arrayed. The array features may also contain other polynucleotides, such as cDNAs, or inserts from phage BACs (bacterial artificial chromosomes) or plasmid clones. While the CGH arrays usually contain features of oligonucleotides, they may also contain features of polynucleotides that are about 201-5000 bases in length, about 5001-50,000 bases in length, or about 50,001-200,000 bases in length, depending on the platform used. If other polynucleotide features are present on a subject array, they may be interspersed with, or in a separately-hybridizable part of the array from, the subject oligonucleotides.

The arrays used with the invention may be prepared by a variety of well-known techniques, including drop deposition from pulse jets or from fluid-filled tips, etc, or using photolithographic means. Polynucleotide precursor units (such as nucleotide monomers), in the case of in situ fabrication, or a previously synthesized polynucleotides (e.g., oligonucleotides, amplified cDNAs or isolated BAC, bacteriophage and plasmid clones, and the like) can be deposited on arrays. Common array fabrication techniques are described in U.S. Pat. No. 6,242,266, U.S. Pat. No. 6,232,072, U.S. Pat. No. 6,180,351, U.S. Pat. No. 6,171,797, and U.S. Pat. No. 6,323,043.

The methods of the invention will be more fully understood by first considering the moving average approach to data smoothing for CGH array data. When analyzing or visually representing array CGH data, it is common to represent the data as a function of the positions of the array probes (oligonucleotide features on an array surface) along each respective chromosome. In the moving average approach to data smoothing, the data at each point or probe position is replaced by the average value of the point of interest and a number of its neighboring points. The number of neighboring points depends on the type of moving average utilized. In some moving averages, the number of points that are averaged is kept fixed at, for example, 3, 5, 7, 9, 11 points, and each point is given equal weight. In other types of moving average smoothing, a window of constant width is moved across the data, and all points within the range of this window, when centered on the point of interest, are averaged to yield the moving average value for the point.

The moving average can be represented by:

$$\overline{y} = \frac{1}{( m + n + 1 )} {\sum }_{i = j - n}^{j + m} {y}_{i} \qquad ( 1 )$$

where \overline{y}ⱼ is the moving average of the measurements yᵢ of the jth point, and j−n and j+m are the first and last points respectively in the moving average. For example, in an 11-point moving average n=in =5, and each point is the average of 11 adjacent points, centered on the sixth point. The individual measurements yᵢ may be raw signals or calculated values from microarray data, such as background-subtracted signals, dye-bias-corrected signals, normalized signals, ratios, log(ratios), log₂(ratios), or other transforms of the any of these measured values.

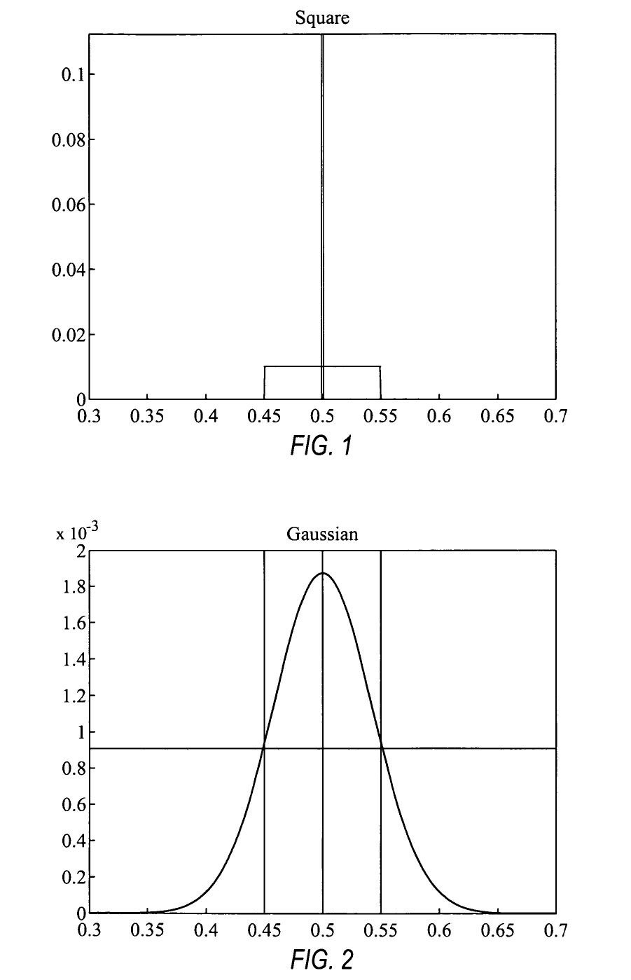

Moving average data smoothing results in a rectangular or “flat-topped” weighting or response function, as shown graphically in FIG. 1, with relative position shown on the x-axis, and relative weighting shown along the y-axis. FIG. 1 shows the moving average response function due to a single non-zero point, centered at x=0.5, generated from a data set of 1000 points on the x-axis.

The greatest drawback of moving average data smoothing is that it obfuscates the resolution of the measurement system, making the effective resolution of the average lower the actual resolution. For example, if a one megabyte (MB) moving average is applied to an array with 100 kilobyte (kB) resolution, a lower uncertainty is gained by averaging together multiple independent measurements. This occurs, however, at the cost of losing the higher resolution of the system by averaging together points that may have independent biological variation. A single point that varies a lot from its neighbor will pull its neighbors in the direction of the change but will be held back by its neighbors as well. As a result, localized or single point changes in copy number are obscured by moving average data smoothing.

Generally, the variance of the weighted mean for a set of points can be expressed in terms of the uncertainties of each of the points as:

$$V ( {\overline{y}}_{j} ) = \frac{{\sum }_{i = j - n}^{j + m} {σ}_{i}^{2} {w}_{i}^{2}}{{( {\sum }_{i = j - n}^{j + m} {w}_{i} )}^{2}} \qquad ( 2 )$$

where σᵢ is the standard deviation of the ith point, and wᵢ is the weight assigned to the ith point.

In the case of a moving average, the weighting function has a constant value over the range of interest and is typically normalized to 1 over its range:

$${\sum }_{i = j - n}^{j + m} {w}_{i} = 1 \qquad ( 3 )$$

If the uncertainty of all data points is assumed to be equal, such as if they were all drawn from a single distribution of points, then the variance of the moving average can be expressed more simply as:

$$V ( {\overline{y}}_{j} ) = \frac{{σ}^{2}}{( m + n + 1 )} = \frac{{σ}^{2}}{{N}_{j}} \qquad ( 4 )$$

where σ is the standard deviation of the distribution of all points, and Nj is the number of points averaged for the jth point, and Nj=m+n+1.

The present invention provides data smoothing methods for CGH array data which utilize weighting or response functions that have a maximum at the center of the function, and which taper off to zero as the distance from the center of the function increases. Such weighting functions include, for example, Gaussian functions, Lorentzian functions, and triangle functions. It should be understood that any weighting function having a maximum at the center, with decreasing weighting (symmetrically or asymmetrically) at increasing distance from the center, may be used with the invention.

The weighting functions used in the invention can be represented more generally by the weighting function w(x) or wᵢ. Weights are referred to as w(x) if the weight depends on the position of the ith point xᵢ by the relation:

$${\overline{y}}_{j} = \frac{{\sum }_{i = j - n}^{j + m} {y}_{i} w ( {x}_{i} )}{{\sum }_{i = j - n}^{j + m} w ( {x}_{i} )} \qquad ( 5 )$$

where each point or value yᵢ is associated with a position in space xᵢ and has an uncertainty σᵢ.

To determine the uncertainties associated with each probe on each chromosome, ideally a sufficient number of experiments would be needed to model the noise at each point, and perhaps even at different copy number values. This approach involves a fairly large number of experiments, typically more than eight (four at each value for at least two distinct known copy number values). With sufficient data, it is possible to calculate the uncertainty for each probe, as well as the intercept value (or dye-bias for two-color experiments) for each probe. In the case where an intercept is calculated on a probe-by-probe basis, yᵢ denotes the bias-corrected data. The variance for the mean for each array probe is then the square of the standard deviation for each point, σᵢ². In such a probe-specific approach the variance of the smoothed point at position xᵢ can be shown by:

$$V ( {\overline{y}}_{j} ) = \frac{{\sum }_{i = j - n}^{j + m} {σ}_{i}^{2} {w ( {x}_{i} )}^{2}}{{( {\sum }_{i = j - n}^{j + m} w ( {x}_{i} ) )}^{2}} \qquad ( 6 )$$

Unfortunately, in many cases it is impractical to carry out enough experiments to reliably measure the uncertainty of each point independently. In such cases, it is reasonable to assume that the populations from which the different array probes are drawn have equal variance, so that the variation across a set of different probes is a good estimate of the variation expected from multiple observations of a single probe. Under this assumption, all probes are assigned the same standard deviation σ, and the variance can be represented by:

$$V ( {\overline{y}}_{j} ) = \frac{{σ}^{2} {\sum }_{i = j - n}^{j + m} {w ( {x}_{i} )}^{2}}{{( {\sum }_{i = j - n}^{j + m} w ( {x}_{i} ) )}^{2}} \qquad ( 7 )$$

Referring now to FIG. 2, there is shown a graphical representation of a Gaussian-shaped weighting function usable with the methods of the invention, with relative chromosomal position shown on the x-axis, and relative weighting shown along the y-axis.

It is desirable that different choices of weighting functions result in comparable degrees of smoothing. To accomplish this, the window width is defined to be twice the horizontal distance that includes ½ of the area under the function. Unlike other measures, such as the full width at half maximum (FWHM), this measure of window width is comparable among different symmetrical weighting functions. The formula for the weights for a Gaussian function is:

$$w ( x ) = \frac{{ⅇ}^{- {x}^{2} / ( 2 {σ}^{2} )}}{σ \sqrt{2 π}} \qquad ( 8 )$$

where σ is the 1/e width of the Gaussian. The nominal window width W for this function is applied is given by:
W=2\sqrt{2}σ*erfinv(0.5)≈1.349σ (9)

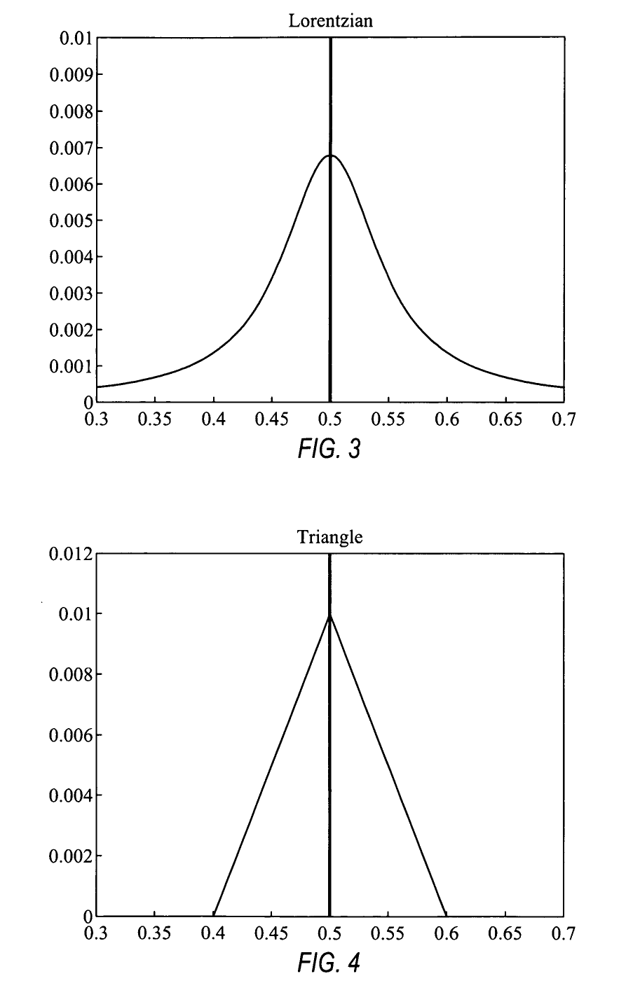

FIG. 3 graphically illustrates a Lorentzian-shaped response function usable with the methods of the invention, with relative chromosomal data point position shown on the x-axis, and relative weighting shown along the y-axis. The Lorentzian weighting function can be represented by:

$$w ( x ) = \frac{W}{π ( {W}^{2} + {x}^{2} )} \qquad ( 10 )$$

where W is the full width half maximum (FWHM) of the Lorentzian, and is 4 times the nominal window width.

A triangle weighting function is graphically illustrated in FIG. 4, where relative chromosomal data point position is again shown on the x-axis, and relative weighting shown along the y-axis. The triangle function has to be defined over each range:

$$w ( x ) = \{ \begin{matrix}0 , \vert x \vert > Δ \\ ( Δ - \vert x \vert ) / {Δ}^{2} , \vert x \vert \leq Δ\end{matrix} \qquad ( 11 )$$

where Δ is the x value at which the sides of the triangle intersect the x axis.

The nominal window width W of the triangle function is given by:
W=(4−2\sqrt{2})Δ (12)

Another weighting function useful with the invention, that is even more peaked than the triangle function, is the biexponential function:
w(x)=e^{-|x|/δ}/2δ (13)
The nominal window width W of the biexponential function is given by:
W=4δ ln(2) (14)

Again, it should be noted that any weighting or response functions that have a maximum at the center of the function, and which taper off as the distance from the center of the function increases, may be used with the methods of the invention, and the aforementioned weighting functions are merely exemplary of some presently preferred shaped weighting functions.

All the weighting functions are in principle applied to all data points for which the weights are nonzero. In practice, however, those weighting functions spanning an infinite domain (e.g. the Gaussian, Lorentzian, and biexponential functions) are applied over a smaller range of x values, for which the weights are significantly different from zero.

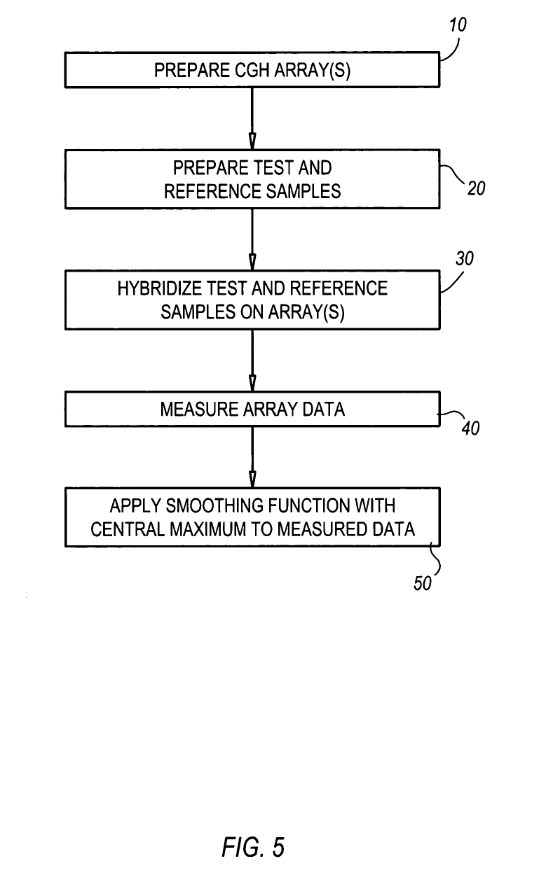

One embodiment of the subject methods is shown in the flow chart of FIG. 5. At event 10, of FIG. 5, a suitable array is prepared for generation of CGH data. Many array platforms are usable with the invention are generally well known in the art (e.g., see Pinkel et al., Nat. Genet. (1998) 20:207-211; Hodgson et al., Nat. Genet. (2001) 29:459-464; and Wilhelm et al., Cancer Res. (2002) 62: 957-960). Such arrays may contain a plurality (i.e., at least about 100, at least about 500, at least about 1000, at least about 2000, at least about 5000, at least about 10,000, at least about 20,000, usually up to about 100,000 or more) of addressable features that are linked to a usually planar solid support. Features on a subject array usually contain a polynucleotide that hybridizes with, i.e., binds to, genomic sequences from a cell. CGH arrays typically have a plurality of different BACs, cDNAs, oligonucleotide primers, or inserts from phage or plasmids, etc., that are addressably arrayed on a substrate surface. CGH arrays thus typically contain surface bound polynucleotides that are about 10-200 bases in length, about 201-5000 bases in length, about 5001-50,000 bases in length, or about 50,001-200,000 bases in length, depending on the platform used and the nature of the CGH experiment. In particular embodiments, CGH arrays containing surface-bound oligonucleotide probes, i.e., oligonucleotides of 10 to 100 nucleotides and up to 200 nucleotides in length, are particularly useful with the invention.

At event 20, test and reference samples are prepared for use with the array of event 10. This event involves obtaining and labeling test and reference genomic samples of nucleic acids. The test and reference samples may comprise, for example, the entire complement of chromosomes of a test cell and reference cell respectively (i.e., the chromosomes that make up the genome of a cell), fragmented versions thereof, amplified copies thereof, or amplified fragments thereof.

The test and reference cells used for sample preparation may be any two cells. In many embodiments, the test cell will have or be suspected of having a different phenotype compared to the reference cell. In a particular embodiment, test and reference cell pairs include cancerous cells, e.g., cells that exhibit increased genomic instability, and non-cancerous cells, respectively or cells obtained from a sample of tissue from a test subject, e.g., a subject suspected of having a chromosome copy number abnormality, and cells obtained from a normal, reference subject, respectively. Test and reference samples may be any cell of interest, including cells that contain or are suspected of containing an abnormal chromosome copy number.

The test and reference samples of nucleic acids may be labeled with the same label or different labels, depending on the actual assay protocol employed. For example, where each sample is to be contacted with different but identical arrays, the test and reference samples may be labeled with the same label. Alternatively, where both samples are simultaneously contacted with a single array, i.e., cohybridized, to the same array, solution-phase collections or populations of nucleic acids that are to be compared are generally distinguishably or differentially labeled with respect to each other.

The test and reference nucleic acid samples may be distinguishably labeled using various well known techniques, such as primer, extension, random-priming, nick translation, and the like. See, e.g., Ausubel, et al., Short Protocols in Molecular Biology, 3rd ed., Wiley & Sons 1995 and Sambrook et al., Molecular Cloning: A Laboratory Manual, Third Edition, 2001 Cold Spring Harbor, N.Y.). “Distinguishable” labels are labels that can be independently detected and measured, even when the labels are mixed. In other words, the amounts of label present for each of the labels are separately determinable, even when the labels are co-located on the same probe feature of an array surface. Suitable distinguishable fluorescent label pairs useful with the invention include Cy-3 and Cy-5 (Amersham Inc., Piscataway, N.J.), Quasar 570 and Quasar 670 (Biosearch Technology, Novato Calif.), Alexafluor555 and Alexafluor647 (Molecular Probes, Eugene, Oreg.), BODIPY V-1002 and BODIPY V1005 (Molecular Probes, Eugene, Oreg.), POPO-3 and TOTO-3 (Molecular Probes, Eugene, Oreg.), fluorescein and Texas red (Dupont, Boston Mass.) and POPRO3 TOPRO3 (Molecular Probes, Eugene, Oreg.).

In certain embodiments the test and reference nucleic acid composition may be of reduced complexity (such as about 20-fold less, about 25-fold less, about 50-fold less, about 75-fold less, about 90-fold less, or at about 95-fold less complex) in terms of total numbers of sequences present in the chromosome composition as compared to the entire chromosome complements of the test and reference cells. Reduction in complexity can be achieved by using sequence specific primers in the generation of labeled nucleic acids, and by reducing the complexity of the chromosomal composition used to prepare the test and reference nucleic acid samples.

After nucleic acid purification and any pre-hybridization steps to suppress repetitive sequences (e.g., hybridization with Cot-1 DNA), the test and reference samples are hybridized onto an array or arrays in event 30. The test and reference nucleic acid samples are contacted to an array surface under conditions such that nucleic acid hybridization to the surface-bound probes can occur. The test and reference samples may be applied in a suitable buffer containing 50% formamide, 5×SSC and 1% SDS at 42° C., or in a buffer containing 5×SSC and 1% SDS at 65° C., both with a wash of 0.2×SSC and 0.1% SDS at 65° C. In many embodiments the test and reference nucleic acids may be contacted with an array surface simultaneously.

Standard hybridization techniques may be used, which may vary in stringency as desired. In certain embodiments, highly stringent hybridization conditions may be employed as described above. Kallioniemi et al., Science 258:818-821 (1992) and WO 93/18186 describe conventional CGH techniques. Several guides to general techniques are available, e.g., Tijssen, Hybridization with Nucleic Acid Probes, Parts I and II (Elsevier, Amsterdam 1993). For a description of techniques suitable for in situ hybridizations, see Gall et al. Meth. Enzymol., 21:470-480 (1981) and Angerer et al. in Genetic Engineering: Principles and Methods Setlow and Hollaender, Eds. Vol 7, pgs 43-65 (plenum Press, New York 1985).

Event 30 also may include post-hybridization washes to remove test and reference nucleic acids not bound to array probes in the hybridization of event 30.

In event 40, array data is measured or determined. Standard detection techniques may be used in reading the hybridization data from an array surface. Where fluorescent labeling of the test and reference nucleic acids is used, reading of the hybridized array may be achieved by illuminating the array and reading the location and intensity of resulting fluorescence at each feature of the array to detect binding complexes on the array surface. A scanner, such as the AGILENT MICROARRAY SCANNER available from Agilent Technologies, Palo Alto, Calif., may be used for measuring data. Arrays may be read by other methods such as other optical techniques (for example, detecting chemiluminescent or electroluminescent labels) or electrical techniques (where each array feature is provided with an electrode to detect hybridization). In the case of indirect labeling, subsequent treatment of the array with the appropriate reagents may be employed to enable reading of the array. Some methods of detection, such as surface plasmon resonance, do not require any labeling of the probe nucleic acids, and are suitable for some embodiments.

At event 50, a weighting or response function having a centrally located maximum is applied to the data measured in event 40. Various weighting or response functions that have a maximum at the center of the function, and which taper off to zero as the distance from the center of the function increases, may be used with the invention as noted above. The response function is applied to data within or across a window of selected width to produce “smoothed” signals from the raw data of event 40. The smoothed data provided by use of shaped response functions with central maximum provide substantially better preservation of point-by-point variations of array data, as well as noise reduction that is necessary to see subtle effects where there are large numbers of probes, than has been achieved using previously known data smoothing methodologies.

Specific examples of such response functions include a Gaussian-shaped function as shown by equation (8), a Lorentzian-shaped function as shown by equation (10), and a triangle-shaped function defined by the ranges of equation (11). The Gaussian-shaped response function may be applied to data across a window of width W as defined by equation (9). The Lorentzian-shaped response function may be applied to data across a window of width equal to the FWHM of the Lorentzian function. The triangle-shaped response function may be applied to data across a window of width W as defined by equation (12).

Event 50 may additionally include calculation of significance level for the data smoothed using a shaped response function with a central maximum. In cases where the probes within the range of interest can be assumed to have equal variance (i.e., noise distribution is equal across the range or chromosome of interest), all probes can be assigned the same standard deviation, and the variance of each smoothed data point can be obtained using equation (7). Where equal variance for the probe range of interest cannot be assumed, and where suitable data is available, the probe-specific variance of equation (6) may be applied to the smoothed data.

Event 50 may include creating a graphical representation of the smoothed data.

Prior to the data smoothing of event 50, raw data from event 40 may be globally normalized such that the normalized test and reference signals are equal on average for a specified subset of “normalization” probes. Alternatively, test signals may be normalized to data obtained from controls (e.g., internal controls produce data that are predicted to be equal in value in all of the data groups). Such normalization may involve multiplying each numerical value for one data group by a value that allows the direct comparison of those amounts to amounts in a second data group. Several normalization strategies have been described (Quackenbush et al, Nat Genet. 32 Suppl:496-501, 2002, Bilban et al Curr Issues Mol. Biol. 4:57-64, 2002, Finkelstein et al, Plant Mol. Biol.48(1-2):119-31, 2002, and Hegde et al, Biotechniques. 29:548-554, 2000). Specific examples of normalization suitable for use in the subject methods include linear normalization methods, non-linear normalization methods, e.g., using Lowess local regression to paired data as a function of signal intensity, signal-dependent non-linear normalization, qspline normalization and spatial normalization, as described in Workman et al., Genome Biol. 2002 3, 1-16. In certain embodiments, the numerical value associated with a feature signal is converted into a log number, either before or after normalization occurs.

Also prior to the data smoothing of event 50, normalized signals may be converted into log ratios of the normalized test signals to the normalized reference signals. In the preferred embodiment, the smoothing function of event 50 is applied to such normalized log ratios.

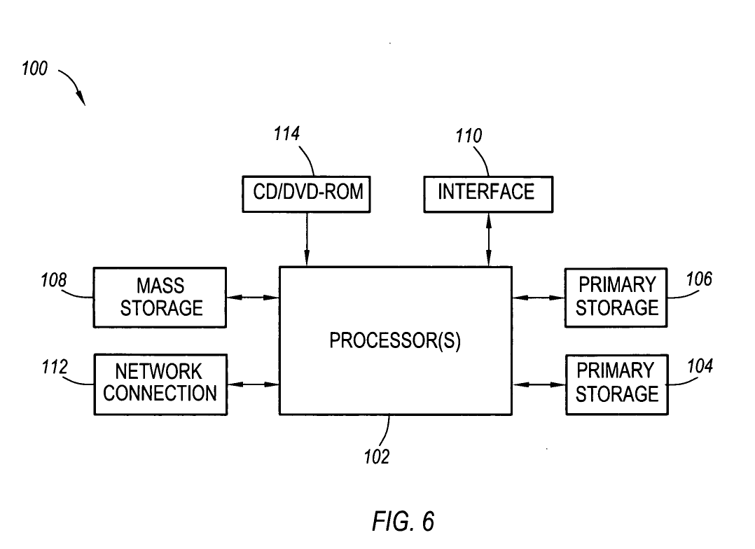

The data smoothing of event 50 will usually be embodied in logic that resides in a computer-readable medium associated with a computer system such as system 100 shown in FIG. 6. The computer system 100 includes any number of processors 102 (also referred to as central processing units, or CPUs) that are coupled to storage devices including primary storage 104 (typically a random access memory, or RAM), primary storage 106 (typically a read only memory, or ROM). As is well known in the art, primary storage 104 acts to transfer data and instructions uni-directionally to the CPU, and primary storage 106 is used typically to transfer data and instructions in a bi-directional manner Both of these primary storage devices may include any suitable computer-readable media containing program elements capable of performing the data smoothing operations described above.

A mass storage device 108 is also coupled bi-directionally to CPU 102 and provides additional data storage capacity and may include any of the computer-readable media described above. Mass storage device 108 may be used to store programs, data and the like and is typically a secondary storage medium such as a hard disk that is slower than primary storage. It will be appreciated that the information retained within the mass storage device 108, may, in appropriate cases, be incorporated in standard fashion as part of primary storage 106 as virtual memory. A specific mass storage device such as a CD-ROM 114 may also pass data uni-directionally to the CPU 102.

CPU 102 is also coupled to an interface 110 that includes one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 102 optionally may be coupled to a computer or telecommunications network using a network connection as shown generally at 112. With such a network connection, it is contemplated that the CPU 102 might receive information from the network, or might output information to the network in the course of performing the above-described method steps. The above-described devices and materials will be familiar to those of skill in the computer hardware and software arts.

The hardware elements described above may implement the instructions of multiple software modules for performing the data smoothing operations of this invention. For example, instructions for applying various shaped response functions having a central maximum to raw or normalized array data, for determining variances for smoothed data points, and for generating graphical representations of smoothed data, may be stored on mass storage device 108 or 114 and executed on CPU 102 in conjunction with primary memory 106.

In addition, embodiments of the present invention further relate to computer readable media or computer program products that include program instructions and/or data (including data structures) for performing various computer-implemented operations. The media and program instructions may be those specially designed and constructed for the purposes of the present invention, or they may be of the kind well known and available to those having skill in the computer software arts. Examples of computer-readable media include, but are not limited to, magnetic media such as hard disks, floppy disks, and magnetic tape; optical media such as CD-ROM, CDRW, DVD-ROM, or DVD-RW disks; magneto-optical media such as “floptical” disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

### EXAMPLE

This example utilized a sample from the human colon carcinoma cell line HCT116 on Chromosome 16. An Agilent Labs prototype array WGA_AlphaV1 (Whole Human Genome array Alpha, Version 1) was used. This array has 5,464 probes for chromosome 16, from which 1000 probes were selected so as to be substantially evenly spaced, from the original gene-biased design. Steps for preparation of such an array are generally well-known and are not detailed here. Further general information about array preparation, including hybridization, may be found in co-pending, commonly owned Application Serial No. (application Ser. No. ______, Attorney's Docket No. 10040074-1) filed on even date herewith and titled “Methods and Compositions for Reducing Label Variation in Array-Based Comparative Genome Hybridization Assays”, which is hereby incorporated herein, in its entirety, by reference thereto.

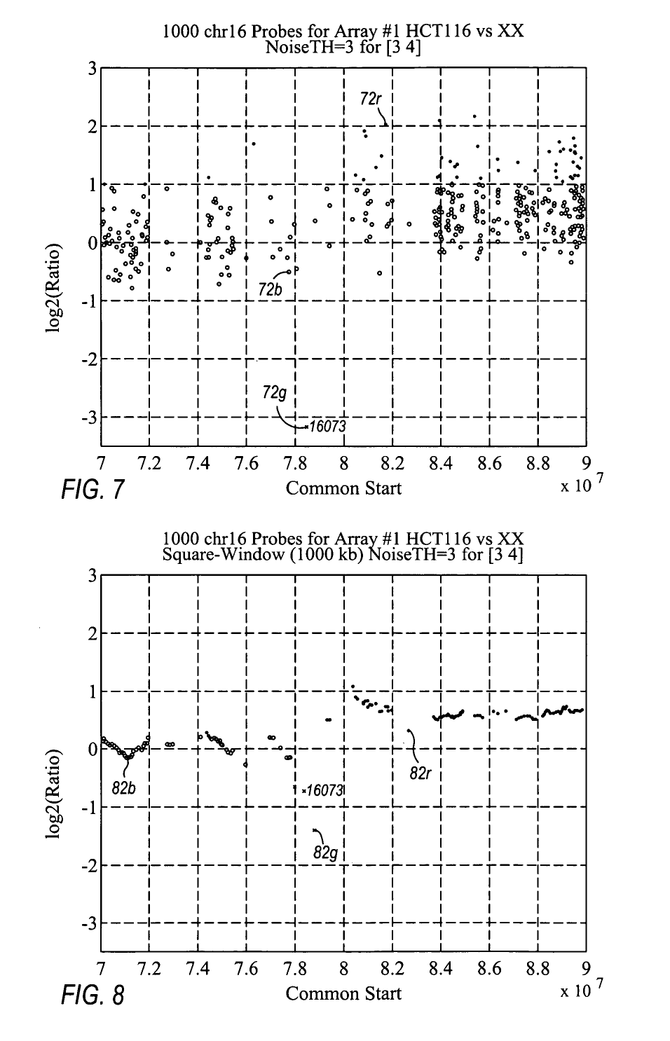

FIG. 7 shows graphically the raw data for a region of the P-arm of chromosome-16 after hybridization of test and reference samples to the WGA_AlphaV1 array and scanning of the array. The raw data is shown as log₂ (Test/Reference, or log₂(ratio), versus chromosome position, with probe positions from 70 MB to 90 MB shown. The raw data is typically colorized according to significance with respect to two relatively normal samples on chromosome 16 (samples in which there were no expected variation in the copy number of probes on Chromosome 16), but in order to meet patent drawing requirements for black and white figures, red data points are shown as solid circles (i.e., •'s) in FIG. 7 (and Figures following) and blue data points are shown as hollow circles (i.e., ∘'s), although in black. The “blue” data points 72b indicate no statistically significant change with respect to the other reference arrays. “Red” data points 72r indicate a significant increase in copy number and “green” data points 72g indicate a significant decrease in copy number. Green data points are represented as x's in the figures. The threshold for the cut off was made using an independent set of “normal” samples where there was no systematic change in copy number of probes on chromosome 16.

In this example, the noise model was one for which the noise of the distribution was considered identical across the whole of chromosome 16, and equation (7) above was used to calculate the significance level of the smoothed signals discussed below.

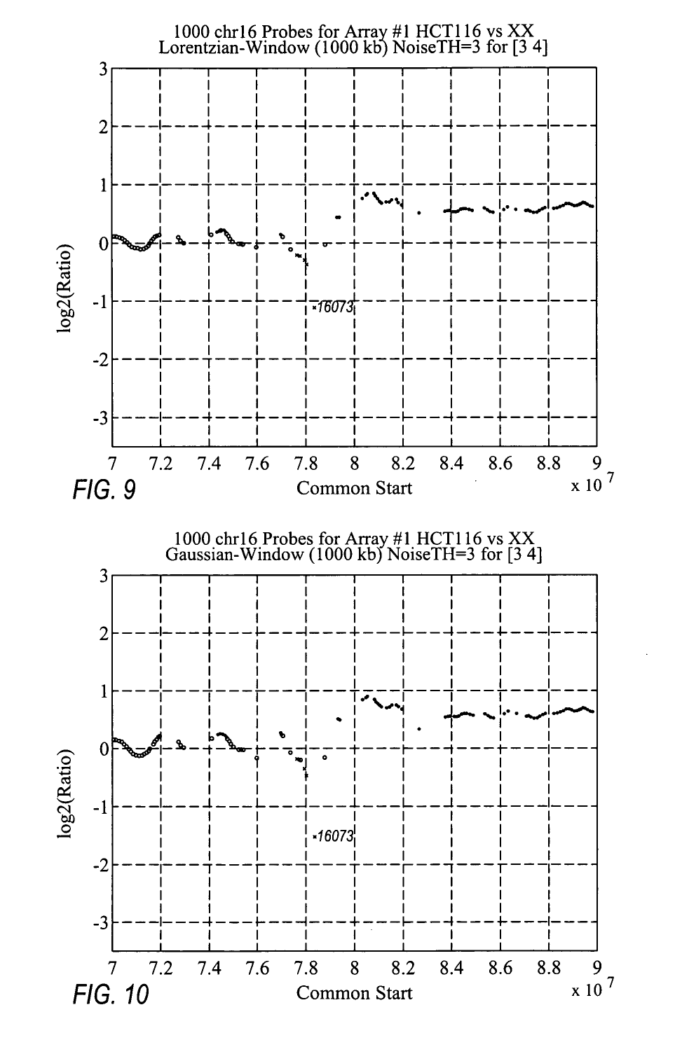

FIG. 8 shows the smoothing obtained by using a moving average (or “square window”) of 1 MB width. The smoothed data points of FIG. 8 are colored red 82r if they are more than 3 standard deviations above zero, and green 82g if they are more three standard deviations below zero. Although the same criteria were used for the raw data of FIG. 7 without smoothing, there are far more significant probes with smoothing because a large region to the right of 81 MB was uniformly amplified, and the moving average of neighboring points with the same nominal value effectively works to reduce the noise. Similarly, the region to the left of 78 MB was un-amplified, and so the data is closer to zero and does not appear significantly amplified.

FIGS. 9, 10 and 11 show the raw data of FIG. 2 after data smoothing using Gaussian-shaped, Lorentzian-shaped, and triangle-shaped response functions respectively over a smoothing window of 500 kB. The window width is defined to be twice the horizontal α-axis) distance that includes ½ of the area under the smoothing function. This measure of window width, unlike other measures such as FWHM, is comparable among different symmetrical smoothing functions having a central maximum.

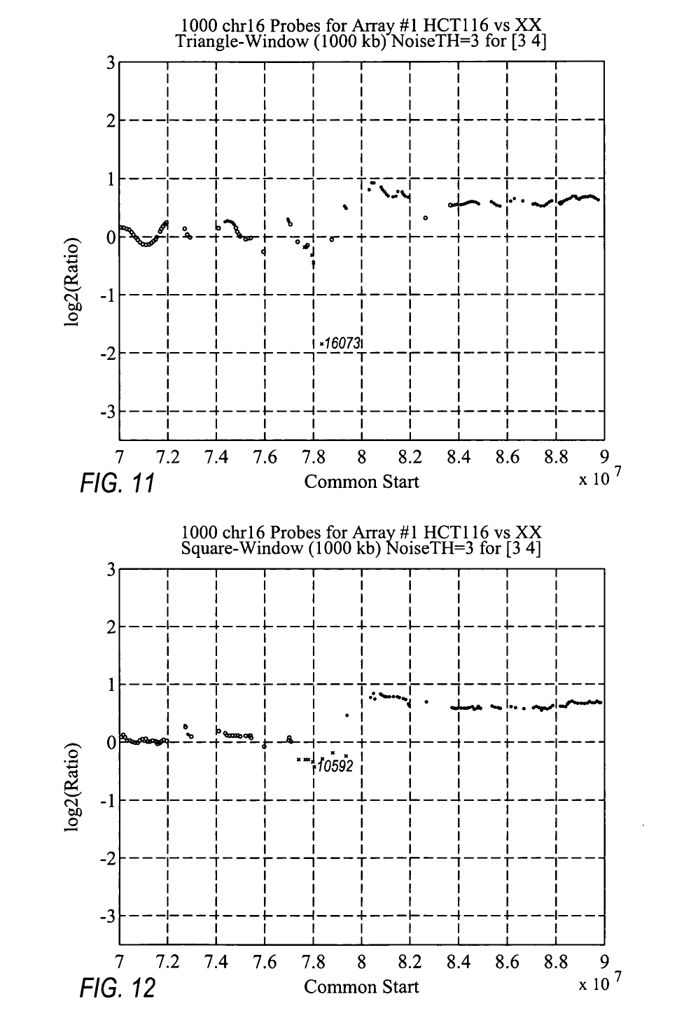

In the raw data of FIG. 7, data point 16073 has the lowest value in terms of log₂(ratio), with a value of about −3.2. Comparing the moving average data smoothing of FIG. 8 to the data smoothing using shaped functions with a central maximum, shown in FIGS. 9-11, one can easily note that data point 16073 is not the lowest point in log₂(ratio) in the moving average-smoothed data of FIG. 8. The square response function obscures the magnitude of this localized copy number reduction, and incorrectly indicates other data points as the lowest of copy number. The shaped response functions with a central maximum provide data smoothing which results in data point 16073 correctly shown as having the lowest copy number. Data smoothing using a triangle shaped function, as shown in FIG. 11, results in point 16073 retaining most of its original value of about −3.2.

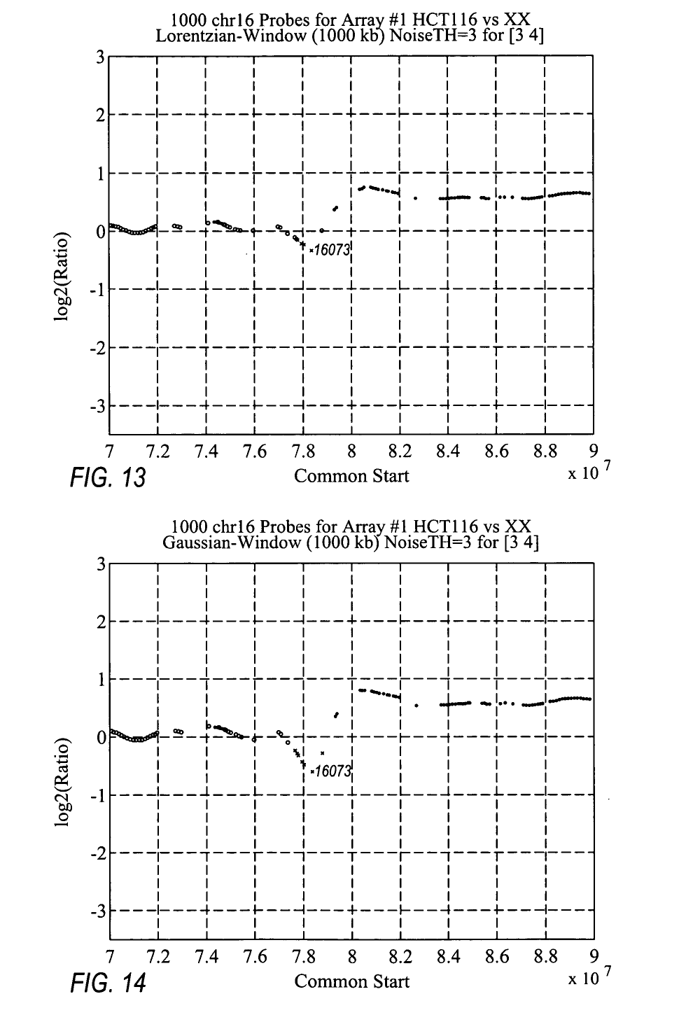

FIG. 12 shows the smoothing obtained by using a moving average (or “square window”) of 2 MB width. Again, it can be seen that data point 16073 is not represented as having the lowest value, as that belongs to data point 10502. Note also that the seven points within the moving average window all appear to have nominally the same value, and it is impossible to determine that any one point is largely deleted.

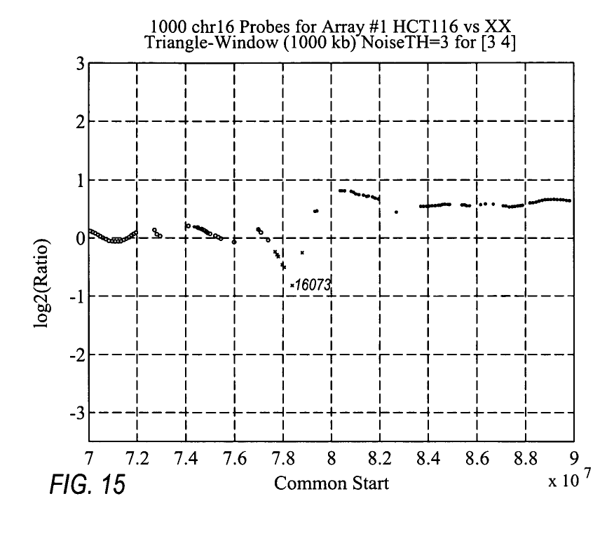

FIGS. 13, 14 and 15 show the raw data of FIG. 2 after data smoothing using Gaussian-shaped, Lorentzian-shaped, and triangle-shaped response functions respectively over a smoothing window of 1 MB. Again, point 16073 correctly stands out as the point of lowest log₂(ratio) value, even though the magnitude of this value is reduced using the larger window.

As can be seen from the above example, shaped response functions having a central maximum provide substantially better preservation of point-by-point variations of array data, while keeping much of the noise reduction that is necessary to see subtle effects where there are large numbers of probes, than is obtained with a flat response moving average function.

While the present invention has been described with reference to the specific embodiments thereof, it should be understood by those skilled in the art that various changes may be made and equivalents may be substituted without departing from the true spirit and scope of the invention. In addition, many modifications may be made to adapt a particular situation, material, composition of matter, process, process step or steps, to the objective, spirit and scope of the present invention. All such modifications are intended to be within the scope of the claims appended hereto.

What is claimed is:

1. A method for smoothing comparative genomic hybridization data, comprising:
(a) measuring comparative genomic hybridization data; and
(b) applying a shaped response function to said comparative genomic hybridization data, said shaped response function having a central maximum.

2. The method of claim 1, wherein said comparative genomic hybridization data is obtained from a comparative genomic hybridization array.

3. The method of claim 1, wherein said shaped response function has a central maximum, and which tapers to zero on each side of said central maximum.

4. The method of claim 3, wherein said shaped response function is symmetrical in shape about said central maximum.

5. The method of claim 4, wherein said shaped response function is a Gaussian-shaped response function of the formula:
$$w ( x ) = \frac{{ⅇ}^{- {x}^{2} / ( 2 {σ}^{2} )}}{σ \sqrt{2 π}}$$
wherein σ is the 1/e width of the Gaussian, and x is data point position.

6. The method of claim 5, wherein the 1/e width of said Gaussian-shaped response function is chosen so that σ is about 1.349 times the nominal window width.

7. The method of claim 4, wherein said shaped response function is a Lorentzian-shaped response function of the formula:
$$w ( x ) = \frac{W}{π ( {W}^{2} + {x}^{2} )}$$
wherein W is the full width half maximum of said Lorentzian-shaped response function, and x is data point position.

8. The method of claim 7, wherein W of said Lorentzian-shaped response function is chosen to be four times the nominal window width.

9. The method of claim 4, wherein said shaped response function is a triangle-shaped response function.

10. The method of claim 4, wherein said shaped response function is a biexponential response function of the formula:
w(x)=e^{-|x|/δ}/2δ
wherein x is data point position and δ is the decay rate of the exponential.

11. The method of claim 10, wherein δ of said biexponential response function is chosen to be 2 ln 2 times the nominal window width.

12. A method for analysis of comparative genomic hybridization array data, comprising:
(a) measuring comparative genomic hybridization array data; and
(b) applying a shaped response function to said comparative genomic hybridization array data, said shaped response function having a central maximum, said shaped response function symmetrically tapering to zero on each side of said central maximum.

13. The method of claim 12, further comprising calculating significance levels for smoothed data obtained from applying said shaped response function to said comparative genomic hybridization array data.

14. The method of claim 13, further comprising generating a graphical representation of said smoothed data.

15. A comparative genomic hybridization array data analysis system, comprising:
(a) means for applying a shaped response function to comparative genomic hybridization array data, said shaped response function having a central maximum, said shaped response function symmetrically tapering to zero on each side of said central maximum;
(b) means for determining significance levels for smoothed data obtained from applying said shaped response function to said comparative genomic hybridization array data; and
(c) means for generating a graphical representation of said smoothed data.

16. The method of claim 15, wherein said shaped response function is a Gaussian-shaped response function of the formula:
$$w ( x ) = \frac{{ⅇ}^{- {x}^{2} / ( 2 {σ}^{2} )}}{σ \sqrt{2 π}}$$
wherein σ is the 1/e width of the Gaussian, and x is data point position.

17. The method of claim 16, wherein the 1/e width of said Gaussian-shaped response function is chosen so that σ is about 1.349 times the nominal window width.

18. The method of claim 15, wherein said shaped response function is a Lorentzian-shaped response function of the formula:
$$w ( x ) = \frac{W}{π ( {W}^{2} + {x}^{2} )}$$
wherein W is the full width half maximum of said Lorentzian-shaped response function, and x is data point position.

19. The method of claim 18, wherein W of said Lorentzian-shaped response function is chosen to be four times the nominal window width.

20. The method of claim 15, wherein said shaped response function is a triangle-shaped response function.

21. The method of claim 15, wherein said shaped response function is a biexponential response function of the formula:
w(x)=e^{-|x|/δ}/2δ
wherein x is data point position and δ is the decay rate of the exponential.

22. The method of claim 21, wherein δ of said biexponential response function is chosen to be 2 ln 2 times the nominal window width.

23. In a computer readable medium, stored programming comprising:
(a) means for applying a shaped response function to comparative genomic hybridization array data, said shaped response function having a central maximum, said shaped response function symmetrically tapering to zero on each side of said central maximum;
(b) means for determining significance levels for smoothed data obtained from applying said shaped response function to said comparative genomic hybridization array data; and
(c) means for generating a graphical representation of said smoothed data.
